(19) United States
(12) Patent Application Publication
(10) Pub. No.: US 2025/0322321 A1
(43) Pub. Date: Oct. 16, 2025

(54) ORDER MANAGEMENT SYSTEM WITH SYNCHRONIZED MULTIPLE PNR CAPABILITY

(71) Applicant: Sabre GLBL Inc., Southlake, TX (US)

(72) Inventors: Srinivas Chalasani, Flower Mound, TX (US); Abhi Vatsya, Euless, TX (US); Vanessa Gonzalez, Flower Mound, TX (US)

(21) Appl. No.: 19/175,519

(22) Filed: Apr. 10, 2025

Related U.S. Application Data
(60) Provisional application No. 63/632,994, filed on Apr. 11, 2024.

(51) Int. Cl. G06Q 10/02; G06Q 50/40

(52) U.S. Cl. CPC G06Q 10/02; G06Q 50/40

(57) ABSTRACT

A method and non-transitory computer readable medium including instructions for executing the method includes using an order management system (OrMS) to generate primary orders and secondary passenger name records (PNRs) therefrom, to generate secondary orders from primary PNRs created by an airline passenger service system (PSS), and to process change data received by the OrMS or PSS. A bidirectional bridge provides communication between the OrMS and the PSS such that that the change data can be synchronized across the systems.

### CROSS-REFERENCE TO RELATED APPLICATION

This application claims priority to and the benefit of U.S. Provisional Patent Application No. 63/632,994 filed on Apr. 11, 2024, and entitled “ORDER MANAGEMENT SYSTEM WITH SYNCHRONIZED MULTIPLE PNR CAPABILITY,” the contents of the above listed application is incorporated herein by reference in its entirety.

### TECHNICAL FIELD

The present disclosure relates to an order management system for use with legacy airline reservation and distribution systems.

### BACKGROUND

Traditional airline reservation and distribution systems are online transactional processing databases which maintain consistency of data either using a single database (mainframe, relational, or other) or, when multiple systems are involved, using legacy protocols (e.g., Electronic Data Interchange for Administration, Commerce and Transport (EDIFACT) or teletype) to synchronize. In such systems, the critical data item (“record”) is the Passenger Name Record (PNR) which track the reservations made on flights operated by one or more airlines booked by a customer, often through a selling agent. This record is used to provide passenger services and in connection with ticketing information (often a separate data record) is used to provide check-in and boarding services. Importantly, the PNR also provides functionality to price and settle monetary transactions between the traveler, airline, and selling agents.

In the airline industry, there has been a movement toward unifying such reservations and ticketing information and replacing PNRs, tickets, and Electronic Miscellaneous Documents (EMDs) with Orders. Orders are intended to provide a super set of the functionality provided by legacy reservation and distribution systems. These additional capabilities include, but are not limited to, the ability to seamlessly sell and service non-airline content such as hotel, car, rail, experiences reservations.

Such Orders can be used as the system of record by any travel service providers, including, but not limited to, Global Distribution System (GDS), Travel Management Corporations (TMCs), or Online Travel Agencies (OTAs), etc.

Airline reservation systems (Passenger Service System or PSS) and distribution systems (Global Distribution System or GDS) are provided by many enterprises. When airlines switch reservation systems, a “hard cutover” is necessary wherein data from one system is converted and transferred into the other and all connectivity within an airline and external interfaces from other systems are all switched over to the new system. Such a process is expensive—a large airline cutover requires hundreds of millions of dollars—and involve significant technical and business risks.

There remains a need for an order management system capable of integrating into legacy systems and facilitating a gradual transition from legacy PNRs, tickets, and EMDs to Orders.

### BRIEF DESCRIPTION OF DRAWINGS

Embodiments of the subject matter are disclosed with reference to the accompanying drawings and are for illustrative purposes only. The subject matter is not limited in its application to the details of construction or the arrangement of the components illustrated in the drawings. Like reference numerals are used to indicate like components, unless otherwise indicated.

FIG. 1 is a diagrammatic illustration showing the creation of an airline booking using a legacy airline PSS.

FIG. 2 is a diagrammatic illustration showing the creation of an airline booking using an order management system according to an embodiment of the present disclosure.

FIG. 3 is a diagrammatic illustration showing the creation of an airline booking using an order management system according to an embodiment of the present disclosure.

FIG. 4 is a diagrammatic illustration showing changes to bookings according to an embodiment of the present disclosure.

FIG. 5 is a flow chart depicting a transition from PNRs to orders according to an embodiment of the present disclosure.

### DETAILED DESCRIPTION

The following descriptions are provided to explain and illustrate embodiments of the present disclosure. The described examples and embodiments should not be construed to limit the present disclosure.

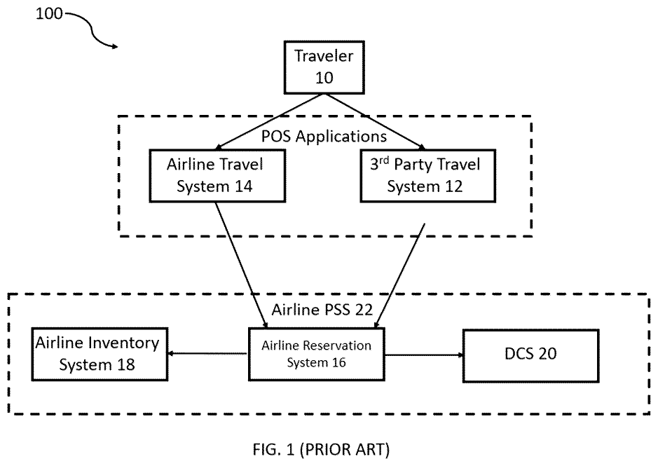

Referring to FIG. 1, a legacy order system 100 is shown. In the legacy system, a traveler 10 uses a point of sale (POS) application such as an airline travel system 14 or a 3^{rd} party travel system 12 to make a travel booking. The traveler 10 may access the POS application using a device (e.g., a computer or smartphone) coupled to the application via a network. The airline travel system 14 or 3^{rd} party travel system 12 then uses an airline PSS 22 to process and manage the request from the traveler 10. The airline PSS 22 includes a reservation system 16, which includes shopping and booking functionality, an airline inventory system 18, which maintains accurate counts of seats sold for each flight and may integrate with a revenue management system (RMS), and a departure control system (DCS), which provides functionality use at an airport, such as check-in, boarding, and closing a flight. The airline PSS 22 creates and stores bookings records as PNRs and may also create and store additional records, such as tickets and EMDS.

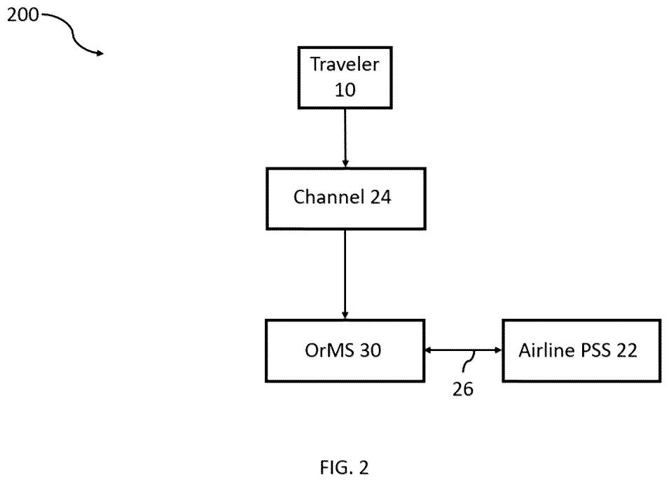

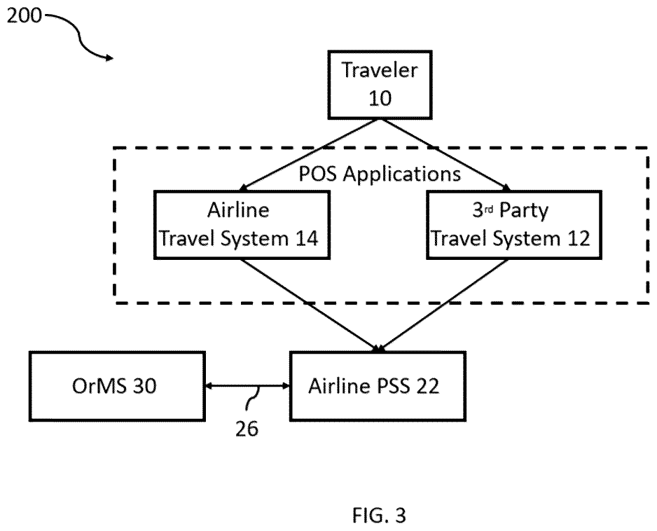

Turning to FIG. 2, a system 200 according to the present disclosure allows a traveler 10 to create an order through an order-enabled channel 24 (e.g., a TMC, OTA, or airline POS application), which requests that the Order Management System (OrMS) 30 create the order. The OrMS 30 then creates an order and an optional PNR in real-time in the airline PSS 22 (herein, a PNR includes other legacy data records such as tickets and EMDs) via bidirectional intelligent bridge 26 in order to maintain synchronization of the order and legacy data records. Additionally, as shown in FIG. 3, the system 200 provides the ability to create orders from a legacy booking route as described with reference to FIG. 1. The OrMS 30 is configured to listen to events happening in the PSS 22 via the bidirectional bridge 26 and create an order from the PNR. As a result, the system 200 provides a full view of all reservations available in OrMS 30, regardless of how they were generated. This allows the airline to have a single dataset view of their entire system, enable offer-based retailing for orders, and accounting and delivery of all transactions as orders. The system 200 may include additional components for carrying out the functions described herein, such as servers, databases, relays, gateways, etc. The OrMS may include any software and/or hardware needed to function as described herein, such as processors, interfaces, or memory. Memory may include random access memory (RAM), read only memory (ROM), magnetic storage devices, optical storage devices, or any other suitable information storage device. Software represents any suitable set of instructions, logic, or code embodied in a computer-readable storage medium.

The system 200 described herein may be employed with any PSS or GDS, such that the enterprise providing an airline with the OrMS 30 need not be the same as the enterprises providing the airline's PSS or GDS. The OrMS 30 may be integrated into existing PSSs and GDSs using standard application programming interfaces (APIs). The OrMS 30 and bidirectional bridge 26 are configured to facilitate both transaction consistency, ensuring Atomicity, Consistency, Isolation and Durability (ACID) and bidirectional eventual consistency, ensuring Basically Available Soft-state and Eventual consistent (BASE).

Orders and PNRs may include overlapping information, such as passenger details (e.g., name, date of birth, etc.) and travel details (e.g., flight information) (collectively referred to herein as operational travel information). Orders and PNRs may also include disparate information. For example, PNRs may include remarks and price quotes that are not part of an order (herein referred to as non-order information). Additionally, orders may include 3^{rd} party content (e.g., hotel, car, or non-traditional content), non-EMD information, and/or offer conditions that are not part of a PNR (collectively referred to herein as non-PNR information).

The order is herein referred to as primary if it was created as shown and described in FIG. 2, in which cases the PNR is referred to as secondary. A primary order will include all of the order information including operational travel information and/or non-PNR information. A secondary PNR will not initially include non-order information and will be initially limited to operational travel information from the primary order. The order is secondary and the PNR is primary if they were created as shown and described in FIG. 3. A primary PNR will include travel operational information and any non-order information. A secondary order will not initially include non-PNR information and will be initially limited to operational travel information from the primary PNR.

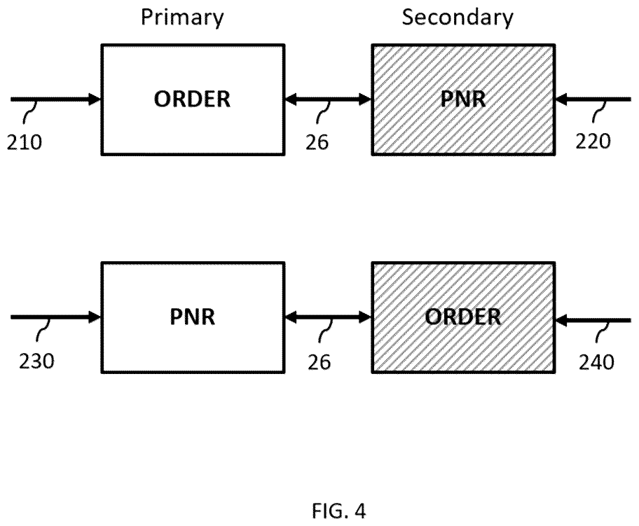

With reference to FIG. 4, the system 200 allows for adjustments of the order and/or PNR regardless of which is primary. Arrow 210 depicts a change or adjustment being made to a primary order via the OrMS 30. If the adjustment pertains to non-PNR information (e.g., 3^{rd} party content, non-EMD information, offer conditions, etc.), the OrMS 30 will not synchronize the adjustment to the PNR. If the adjustment pertains to operational travel information (e.g., passenger details or flight information), the OrMS 30 will synchronize the adjustment to the PNR via the bidirectional bridge 26. Arrow 220 depicts a change or adjustment being made to a secondary PNR via the PSS 22. If the adjustment pertains to non- order information (e.g., remarks or price quotes), the OrMS 30 will not synchronize the adjustment to the order. If the adjustment pertains to operational travel information (e.g., passenger details or flight information), the OrMS 30 will synchronize the adjustment to the order via the bidirectional bridge 26.

Arrow 230 depicts a change or adjustment being made to a primary PNR via the PSS 22. If the adjustment pertains to non-order information (e.g., remarks or price quotes), the OrMS 30 will not synchronize the adjustment to the order. If the adjustment pertains to operational travel information (e.g., passenger details or flight information), the OrMS 30 will synchronize the adjustment to the order via bidirectional bridge 26. Arrow 240 depicts a change or adjustment being made to a secondary order via the OrMS 30. If the adjustment pertains to non-PNR information (e.g., 3^{rd} party content being added), the OrMS 30 will not synchronize the adjustment to the PNR. If the adjustment pertains to operational travel information (e.g., passenger details or flight information), the OrMS 30 will synchronize the adjustment to the PNR via the bidirectional bridge 26.

In some embodiments, the change data may include both non-order information or non-PNR information and operational travel information. The system 200 may determine the character of the change data and bifurcate it into non-order/non-PNR information change data (a first change data) and operational travel information change data (a second change data). The system 200 may then utilize the procedures described above for each of the first change data and the second change data. In such embodiments, the change data received may only be partially synchronized with the PNR or order, thereby improving efficiency.

Returning to FIG. 2, the system 200 also allows for bypassing the PNR creation process for situations in which a PNR is not required. For example, if the order created by the OrMS 30 does not include operational travel information, the OrMS 30 will not create a secondary PNR from the primary order. In some embodiments, this feature may be extended to additional orders as the airline phases out their own legacy PSS and becomes an order-only airline. In such embodiments, the airline may make rules for the OrMS 30 to decide whether a secondary PNR is required. For example, an order that is restricted to the order-only airline and/or other order-only airlines or 3^{rd} parties may not need a secondary PNR. Orders that involve airlines or 3^{rd} parties that are still operating on legacy PNR systems would need a secondary PNR for legacy connectivity until there is an appropriate connectivity mechanism that bypasses the need for secondary PNR.

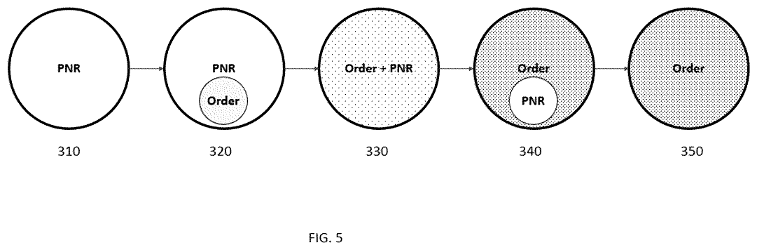

FIG. 5 shows the use of the present system 200 for transitioning from PNRs to orders. Step 310 is a legacy only ecosystem, in which only PNRs are created. Step 320 introduces orders, which are synchronized into PNRs or created from a subset of PNRs (e.g., by airlines using the system 200). Step 330 is where every booking includes both a PNR and an order, and all systems and processes are configured to work with orders. In step 340, bookings are made as orders and PNRs are only created for a subset needing legacy connectivity. Step 350 is a complete transition to orders.

The present disclosure also provides a non-transitory computer readable medium storing a computer-executable program code instructions, wherein the computer-executable program code instructions include instruction for receiving, at a computing device, from a traveler, airline, or third-party device, booking data. When the booking data is legacy data (PNR) received via a legacy channel, the instructions include generating a secondary order from the legacy data via the OrMS. Receiving the booking data may include retrieving a primary PNR created by an airline PSS and generating the secondary order may include generating the secondary order from said primary PNR. When the booking data is order data received via an order-enabled channel, the instructions include generating a primary order via the OrMS, and include generating an optional secondary PNR from the primary order via the OrMS (if the order data includes operational travel information), and communicating the secondary PNR to an airline PSS.

The instructions may additionally include receiving, at a computing device, from a traveler, airline, or third-party device, change data. When the change data relates to a primary order, the instructions include determining, via the OrMS, whether the change data includes operational travel information. If the change data does not include operational travel information, the instructions include modifying the primary order via the OrMS to include the change data and not modifying the secondary PNR (or not communicating the change data to the airline PSS). If the change data includes operational travel information, the instructions include modifying the primary order via the OrMS to include the change data and sending the change data to the airline PSS to modify the secondary PNR.

When the change data relates to a primary PNR (received via the airline PSS), the instructions include retrieving the change data and determining whether the change data includes operational travel information. If the change data does not include operational travel information, the instructions may include modifying the primary PNR via the airline PSS and not modifying the secondary order. If the change data includes operational travel information, the instructions may include modifying the primary PNR via the airline PSS to include the change data and include modifying the secondary order via the OrMS to include the change data.

When the change data relates to a secondary order, the instructions include determining, via the OrMS, whether the change data includes operational travel information. If the change data does not include operational travel information, the instructions include modifying the secondary order via the OrMS to include the change data and not modifying the primary PNR (or not communicating the change data to the airline PSS). If the change data includes operational travel information, the instructions include modifying the secondary order via the OrMS to include the change data and sending the change data to the airline PSS to modify the PNR via the OrMS.

When the change data relates to a secondary PNR, the instructions include determining, via the OrMS, whether the change data includes operational travel information. If the change data does not include operational travel information, the instructions may include modifying the secondary PNR via the airline PSS and not modifying the primary order. If the change data includes operational travel information, the instructions include may modifying the secondary PNR via the airline PSS to include the change data and include modifying the primary order via the OrMS to include the change data.

In some embodiments, the change data may include both non-order information or non-PNR information and operational travel information. The instructions may include using the OrMS to determine the character of the change data and bifurcating it into non-order/non-PNR information change data (order-unique or PNR-unique change data) and operational travel information change data. The instructions may then address the each of the bifurcated change data as detailed above. In such embodiments, the change data received may only be partially synchronized with the PNR or order, thereby improving efficiency.

The methods, systems, and non-transitory computer readable medium disclosed herein may provide improved efficiency for existing airline systems by reducing unnecessary communication when change data is not applicable to both the order and the PNR. They may also enable the transition from legacy systems to order-only systems, wherein orders can provide more robust capabilities such as integration with 3^{rd} party vendors.

A non-transitory computer readable medium storing a computer-executable program code instructions has been disclosed herein. The computer-executable program code instructions include instructions for: receiving, at a first computing device, order data received via an order-enabled channel from a traveler, airline, or third-party device; generating a primary order via an order management system (OrMS); determining, via the OrMS, whether the order data includes operational travel information; generating a secondary passenger name record (PNR) from the primary order via the OrMS and communicating the secondary PNR to an airline passenger service system (PSS) via a bidirectional bridge if the order data includes the operational travel information; retrieving, via the bidirectional bridge, a primary PNR; generating a secondary order from the primary PNR via the OrMS; and
(i) receiving first change data related to the primary order via the OrMS; determining, via the OrMS, whether the first change data includes first operational travel information change data; and modifying the primary order via the OrMS to include the first change data and not communicating the first operational travel information change data to the airline PSS if the first change data does not include the first operational travel information change data; or modifying the primary order via the OrMS to include the first change data and communicating the first operational travel information change data to the airline PSS via the bidirectional bridge if the first change data includes the first operational travel information change data; or
(ii) retrieving second change data related to the primary PNR from the airline PSS via the directional bridge to the OrMS; determining, via the OrMS, whether the second change data includes second operational travel information change data; and modifying the secondary order via the OrMS to include the second operational travel information change data if the second change data includes the second operational travel information change data; or
(iii) receiving third change data related to the secondary order via the OrMS; determining, via the OrMS, whether the third change data includes third operational travel information change data; and modifying the secondary order via the OrMS to include the third change data; communicating the third operational travel information change data to the airline PSS via the bidirectional bridge if the third change data includes the third operational travel information change data; or
(iv) retrieving fourth change data related to the secondary PNR from the airline PSS via the directional bridge to the OrMS; determining, via the OrMS, whether the fourth change data includes fourth operational travel information change data; and modifying the primary order via the OrMS to include the fourth operational travel information change data if the fourth change data includes the fourth operational travel information change data.

The non-transitory computer readable medium may include any one or more of the following features:
wherein the instructions include instructions for receiving the first change data, optionally wherein the first change data includes the first operational travel information change data and non-PNR change data and wherein communicating the first operational travel information change data to the airline PSS comprises communicating only the first operational travel information change data and not the non-PNR change data;
wherein the instructions include instructions for retrieving the second change data, optionally wherein the second change data includes the second operational travel information change data and non-order change data and wherein modifying the secondary order comprises modifying the secondary order to include only the second operational travel information change data and not the non-order change data;
wherein the instructions include instructions for receiving the third change data, optionally wherein the third change data includes the third operational travel information change data and non-PNR change data and wherein communicating the third operational travel information change data to the airline PSS comprises communicating only the third operational travel information change data and not the non-PNR change data; and/or
wherein the instructions include instructions for retrieving the fourth change data, optionally wherein the fourth change data includes the fourth operational travel information change data and non-order change data and wherein modifying the primary order comprises modifying the primary order to include only the fourth operational travel information change data and not the non-order change data.

A method of executing the non-transitory computer readable medium described above has been disclosed herein.

A method has been disclosed herein. The method includes: receiving order data at an order management system (OrMS); using the OrMS, generating a primary order from the order date; extracting, via the OrMS, operational travel information from the order data; using the OrMS, generating a secondary passenger name record (PNR) from the operational travel information; using a bidirectional bridge, communicating the secondary PNR to an airline passenger service system (PSS); and
receiving, via the OrMS, first change data related to the primary order; using the OrMS, determining whether the first change data includes first operational travel information change data; modifying the primary order via the OrMS to include the first change; and if the first change data is determined to include the first operational travel information change data, using the bidirectional bridge, communicating the first operational travel information change data to the airline PSS; or
(ii) using the bidirectional bridge, retrieving second change data from the airline PSS to the OrMS; using the OrMS, determining whether the second change data includes second operational travel information change data; and if the second change data is determined to include the second operational travel information change data, modifying the primary order via the OrMS to include the second operational travel information change data.

The method may include any one or more of the following features:
receiving the first change data, optionally wherein the first change data comprises first operational travel information change data and non-PNR data and wherein communicating the first operational travel information change data comprises communicating only the first operational travel information change data and not the non-PNR change data; and/or
retrieving the second change data, optionally wherein the second change data includes the second operational travel information change data and non-order change data and wherein modifying the primary order comprises modifying the primary order to include only the second operational travel information change data and not the non-order change data.

A method has been disclosed herein. The method includes: using a bidirectional bridge providing communication between an order management system (OrMS) and an airline passenger service system (PSS), retrieving a primary passenger name record (PNR) created by the airline PSS; using the OrMS, generating a secondary order from the primary PNR; and
(i) using the bidirectional bridge, retrieving first change data from the airline PSS to the OrMS; using the OrMS, determining whether the first change data includes first operational travel information change data; and if the first change data is determined to include the first operational travel information change data, modifying the secondary order via the OrMS to include the first operational travel information change data; or
(ii) receiving, via the OrMS, second change data related to the secondary order; using the OrMS, determining whether the second change data includes second operational travel information change data; modifying the secondary order via the OrMS to include the second change; and if the second change data is determined to include the second operational travel information change data, using the bidirectional bridge, communicating the second operational travel information change data to the airline PSS.

The method may include any one or more of the following features:
receiving the first change data, optionally wherein the first change data includes the first operational travel information change data and non-order change data and wherein modifying the secondary order comprises modifying the secondary order to include only the first operational travel information change data and not the non-order change data; and/or
receiving the second change data, optionally wherein the second change data comprises second operational travel information change data and non-PNR data and wherein communicating the second operational travel information change data comprises communicating only the second operational travel information change data and not the non-PNR change data.

Although the present disclosure has been described using preferred embodiments and optional features, modification and variation of the embodiments herein disclosed can be foreseen by those of ordinary skill in the art, and such modifications and variations are considered to be within the scope of the present disclosure. It is also to be understood that the above description is intended to be illustrative and not restrictive. Many alternative embodiments will be apparent to those of ordinary skill in the art upon reviewing the above description. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the disclosure.

Embodiments of the present disclosure may be implemented by various means, such as hardware, firmware, processor, circuitry and/or other devices associated with execution of software including one or more computer program instructions. For example, one or more of the procedures or activities described above may be embodied by computer program instructions. In this regard, the computer program instructions which embody the procedures or activities described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody means for implementing the functions specified in the corresponding procedure or activity. These computer program instructions may also be stored in a computer-readable storage memory (as opposed to a computer-readable transmission medium such as a carrier wave or electromagnetic signal) that may direct a computer or other programmable apparatus to function in a particular manner, such that the instructions stored in the computer-readable memory produce an article of manufacture the execution of which implements the function specified in the corresponding procedure or activity. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the corresponding procedure or activity described above.

What is claimed is:

1. A non-transitory computer readable medium storing a computer-executable program code instructions, wherein the computer-executable program code instructions include instructions for:
receiving, at a first computing device, order data received via an order-enabled channel from a traveler, airline, or third-party device;
generating a primary order via an order management system (OrMS);
determining, via the OrMS, whether the order data includes operational travel information;
generating a secondary passenger name record (PNR) from the primary order via the OrMS and communicating the secondary PNR to an airline passenger service system (PSS) via a bidirectional bridge if the order data includes the operational travel information;
retrieving, via the bidirectional bridge, a primary PNR;
generating a secondary order from the primary PNR via the OrMS; and
(i) receiving first change data related to the primary order via the OrMS;
determining, via the OrMS, whether the first change data includes first operational travel information change data; and
modifying the primary order via the OrMS to include the first change data and not communicating the first operational travel information change data to the airline PSS if the first change data does not include the first operational travel information change data; or
modifying the primary order via the OrMS to include the first change data and communicating the first operational travel information change data to the airline PSS via the bidirectional bridge if the first change data includes the first operational travel information change data; or
(ii) retrieving second change data related to the primary PNR from the airline PSS via the directional bridge to the OrMS;
determining, via the OrMS, whether the second change data includes second operational travel information change data; and
modifying the secondary order via the OrMS to include the second operational travel information change data if the second change data includes the second operational travel information change data; or
(iii) receiving third change data related to the secondary order via the OrMS;
determining, via the OrMS, whether the third change data includes third operational travel information change data; and
modifying the secondary order via the OrMS to include the third change data;
communicating the third operational travel information change data to the airline PSS via the bidirectional bridge if the third change data includes the third operational travel information change data; or
(iv) retrieving fourth change data related to the secondary PNR from the airline PSS via the directional bridge to the OrMS;
determining, via the OrMS, whether the fourth change data includes fourth operational travel information change data; and
modifying the primary order via the OrMS to include the fourth operational travel information change data if the fourth change data includes the fourth operational travel information change data.

2. The non-transitory computer readable medium of claim 1, wherein the instructions include instructions for receiving the first change data.

3. The non-transitory computer readable medium of claim 2, wherein the first change data includes the first operational travel information change data and non-PNR change data and wherein communicating the first operational travel information change data to the airline PSS comprises communicating only the first operational travel information change data and not the non-PNR change data.

4. The non-transitory computer readable medium of claim 1, wherein the instructions include instructions for retrieving the second change data.

5. The non-transitory computer readable medium of claim 4, wherein the second change data includes the second operational travel information change data and non-order change data and wherein modifying the secondary order comprises modifying the secondary order to include only the second operational travel information change data and not the non-order change data.

6. The non-transitory computer readable medium of claim 1, wherein the instructions include instructions for receiving the third change data.

7. The non-transitory computer readable medium of claim 6, wherein the third change data includes the third operational travel information change data and non-PNR change data and wherein communicating the third operational travel information change data to the airline PSS comprises communicating only the third operational travel information change data and not the non-PNR change data.

8. The non-transitory computer readable medium of claim 1, wherein the instructions include instructions for retrieving the fourth change data.

9. The non-transitory computer readable medium of claim 8, wherein the fourth change data includes the fourth operational travel information change data and non-order change data and wherein modifying the primary order comprises modifying the primary order to include only the fourth operational travel information change data and not the non-order change data.

10. A method comprising executing the non-transitory computer readable medium of claim 1.

11. A method comprising:
receiving order data at an order management system (OrMS);
using the OrMS, generating a primary order from the order date;
extracting, via the OrMS, operational travel information from the order data;
using the OrMS, generating a secondary passenger name record (PNR) from the operational travel information;
using a bidirectional bridge, communicating the secondary PNR to an airline passenger service system (PSS); and
(i) receiving, via the OrMS, first change data related to the primary order;
using the OrMS, determining whether the first change data includes first operational travel information change data;
modifying the primary order via the OrMS to include the first change; and
if the first change data is determined to include the first operational travel information change data, using the bidirectional bridge, communicating the first operational travel information change data to the airline PSS; or
(ii) using the bidirectional bridge, retrieving second change data from the airline PSS to the OrMS;
using the OrMS, determining whether the second change data includes second operational travel information change data; and
if the second change data is determined to include the second operational travel information change data, modifying the primary order via the OrMS to include the second operational travel information change data.

12. The method of claim 11, comprising receiving the first change data.

13. The method of claim 12, wherein the first change data comprises first operational travel information change data and non-PNR data and wherein communicating the first operational travel information change data comprises communicating only the first operational travel information change data and not the non-PNR change data.

14. The method of claim 11, comprising retrieving the second change data.

15. The method of claim 14, wherein the second change data includes the second operational travel information change data and non-order change data and wherein modifying the primary order comprises modifying the primary order to include only the second operational travel information change data and not the non-order change data.

16. A method comprising:
using a bidirectional bridge providing communication between an order management system (OrMS) and an airline passenger service system (PSS), retrieving a primary passenger name record (PNR) created by the airline PSS;
using the OrMS, generating a secondary order from the primary PNR; and
(i) using the bidirectional bridge, retrieving first change data from the airline PSS to the OrMS;
using the OrMS, determining whether the first change data includes first operational travel information change data; and
if the first change data is determined to include the first operational travel information change data, modifying the secondary order via the OrMS to include the first operational travel information change data; or
(ii) receiving, via the OrMS, second change data related to the secondary order;
using the OrMS, determining whether the second change data includes second operational travel information change data;
modifying the secondary order via the OrMS to include the second change; and
if the second change data is determined to include the second operational travel information change data, using the bidirectional bridge, communicating the second operational travel information change data to the airline PSS.

17. The method of claim 16, comprising retrieving the first change data.

18. The method of claim 17, wherein the first change data includes the first operational travel information change data and non-order change data and wherein modifying the secondary order comprises modifying the secondary order to include only the first operational travel information change data and not the non-order change data.

19. The method of claim 16, comprising receiving the second change data.

20. The method of claim 19, wherein the second change data comprises second operational travel information change data and non-PNR data and wherein communicating the second operational travel information change data comprises communicating only the second operational travel information change data and not the non-PNR change data.
